(19) United States
(12) Patent Application Publication
(10) Pub. No.: US 2026/0252049 A1
(43) Pub. Date: Aug. 27, 2026

(54) CONTROL DEVICE, CONTROL METHOD, AND RECORDING MEDIUM

(71) Applicant: Hitachi, Ltd., Tokyo (JP)

(72) Inventors: Kanako ESAKI, Tokyo (JP); Tadayuki MATSUMURA, Tokyo (JP); Hiroyuki MIZUNO, Tokyo (JP)

(21) Appl. No.: 19/535,101

(22) Filed: Feb. 10, 2026

(30) Foreign Application Priority Data
Feb. 27, 2025 (JP) 2025-029701

(51) Int. Cl. G05B 15/02

(52) U.S. Cl. CPC G05B 15/02

(57) ABSTRACT

A control device include: a storage unit for storing an observation preference distribution of each task target as a target of a task in which a control target operates, and obstacle degree information indicating a degree that the task target corresponds to an obstacle; an estimation unit for estimating that an object in an ambient environment of the control target is which task target based on observation data from a sensor for observing the ambient environment of the control target and the observation preference distribution; a calculation unit for calculating an obstacle spectrum indicating an obstacle degree of a result of estimation based on the obstacle degree information; a generation unit for generating an action of the control target based on the estimation result; and a planning unit for planning control data which controls the control target based on an obstacle spectrum calculated and an action generated.

### CLAIM OF PRIORITY

The present application claims priority from Japanese patent application No. 2025-029701 filed on Feb. 27, 2025, the content of which is hereby incorporated by reference into this application.

### BACKGROUND

The present invention relates to a control device, a control method, and a control program for controlling a control target.

A collaborative robot is a robot which works sharing a physical space with humans, and an expectation for the robot as the existence to complement work force is becoming higher. There is, however, a challenge to satisfy both safety and approachability (easiness for a collaborative robot to approach humans) of a collaborative robot.

A conventional collaborative robot has safety functions determined by the International Organization for Standardization (ISO). A conventional collaborative robot satisfies both safety and approachability by detecting an obstacle and making a stop or deceleration during operation of the collaborative robot, or making a stop when the collaborative robot collides with an obstacle.

Japanese Unexamined Patent Application Publication No. 2023-132333 discloses a robot which avoids a human so as not to come into contact when the human comes closer. This robot includes: a sensor unit which is attached to a robot having a driving unit and detects an obstacle existing around the robot; and a control unit that controls driving of the robot. The control unit includes: a spatial distance calculation unit for calculating a spatial distance between a robot and an obstacle via the sensor unit; a virtual external force calculation unit for calculating a virtual external force by regarding an influence exerted when an obstacle comes closer to the robot as a virtual external force on the basis of the spatial distance; an operation speed suppressing unit for regarding the influence exerted when the obstacle comes closer to the robot as a virtual external force on the basis of the spatial distance and suppressing program operation speed of the robot in accordance with the external force; and an operation adjustment unit for adjusting operation of the driving unit on the basis of the virtual external force to thereby avoid contact between the robot and the obstacle.

### SUMMARY

It is expected that a collaborative robot will be used in more flexible cases in future. In a case where the movements of a robot and an obstacle are not defined in advance, approachability is lost. Concretely, when the way of handling an obstacle varies among targets (there are various obstacles such as an obstacle which should be avoided, an obstacle which can be approached, and an obstacle which can be contacted), the conventional obstacle detecting method (0 or 1 indicating whether it is an obstacle or not) cannot handle it. When a robot operates adaptationally in accordance with situations (when a trajectory is planned and executed in a real-time manner), it is impossible to detect an obstacle during planning of a trajectory and impossible to generate a trajectory. Also in such a case which is more flexible than a conventional one as described above, both safety and approachability have to be satisfied. In Japanese Unexamined Patent Application Publication No. 2023-132333, the movement of a robot which is generated is limited to a spatial distance.

An object of the present invention is to realize both safety and approachability of a control target in accordance with characteristics of a target of a task in which the control target operates.

A control device of one aspect of the technique of the present disclosure include: a storage unit for storing an observation preference distribution of each task target as a target of a task in which a control target operates, and obstacle degree information indicating a degree that the task target corresponds to an obstacle; an estimation unit for estimating that an object in an ambient environment of the control target is which task target on the basis of observation data from a sensor for observing the ambient environment of the control target and the observation preference distribution; a calculation unit for calculating an obstacle spectrum indicating an obstacle degree of a result of estimation by the estimation unit on the basis of the obstacle degree information; a generation unit for generating an action of the control target on the basis of the estimation result; and a planning unit for planning control data which controls the control target on the basis of an obstacle spectrum calculated by the calculation unit and an action generated by the generation unit.

According to the representative embodiments of the present invention, it is possible to realize both safety and approachability of the control target in accordance with characteristics of the target of the task in which the control target operates. The other objects, configurations, and effects will become apparent by the following description of embodiments.

### BRIEF DESCRIPTION OF THE DRAWINGS

FIG. 1 is an explanatory diagram illustrating an example of controlling a robot arm according to a first embodiment.

FIG. 2 is a block diagram illustrating a hardware configuration example of a control device.

FIG. 3 is an explanatory diagram illustrating an example of a task goal table.

FIG. 4 is an explanatory diagram illustrating an example of an obstacle degree information table.

FIG. 5 is an explanatory diagram illustrating an example of an index determination table.

FIG. 6 is an explanatory diagram illustrating an example of a selection table.

FIG. 7 is a block diagram illustrating a functional configuration example of the control device.

FIG. 8 is an explanatory diagram illustrating a calculation result example of a probability distribution.

FIG. 9 is an explanatory diagram illustrating an example of a calculation result of an obstacle spectrum.

FIG. 10 is an explanatory diagram illustrating trajectory plan example 1.

FIG. 11 is an explanatory diagram illustrating trajectory plan example 2.

FIG. 12 is an explanatory diagram illustrating a procedure example of a control operation on the robot arm by the control device according to the first embodiment.

FIG. 13 is an explanatory diagram illustrating a procedure example of a control operation on the robot arm by a control device according to a second embodiment.

FIG. 14 is an explanatory diagram illustrating Example 1 of controlling a trolley robot according to a third embodiment.

FIG. 15 is an explanatory diagram illustrating Example 2 of controlling the trolley robot according to the third embodiment.

FIG. 16 is an explanatory diagram illustrating a trajectory plan example according to the third embodiment.

### DETAILED DESCRIPTION

### FIRST EMBODIMENT

In a first embodiment, an example of controlling a robot arm so as to detect and avoid an obstacle in a task of grasping an object by the robot arm as an example of an actuator will be described. It is assumed that the position of the robot arm is fixed.

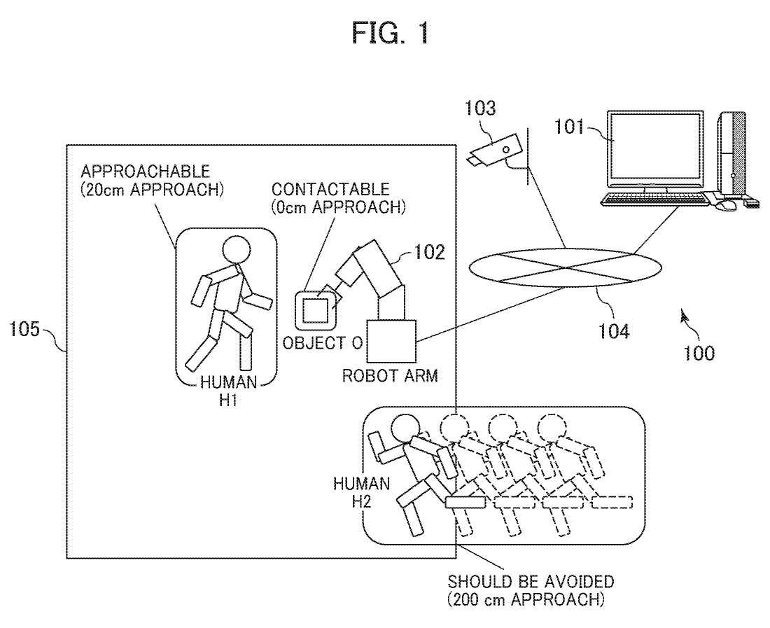

### FIG. 1 Example of Robot Arm Control

FIG. 1 is an explanatory diagram of an example of controlling a robot arm according to the first embodiment. A control system 100 has a control device 101, a robot arm 102, and a sensor 103. The control device 101, the robot arm 102, and the sensor 103 are communicably connected via a network 104 (which may be wired or wireless) such as the Internet, an LAN (Local Area Network), a WAN (Wide Area Network), or the like.

The control device 101 is a computer for controlling the robot arm 102. The robot arm 102 is a control target of the control device 101. Concretely, for example, the robot arm 102 is an actuator of executing a task of grasping an object on the basis of control data from the control device 101. The robot arm 102 has a plurality of joints operated by six axes and grasps an object by its hand. The sensor 103 detects an ambient environment 105 of the robot arm 102.

The sensor 103 is, for example, a camera, shoots an object in the ambient environment 105, and determines a three-dimensional position of the object in a camera coordinate system. The sensor 103 may include an infrared sensor. That is, the sensor 103 is not limited to a camera as long as it can detect an object in the ambient environment 105. The sensor 103 may be provided to the robot arm 102.

An object O is a non-obstacle and is a target to be grasped by the robot arm 102. The object O is disposed in a position where it can be contacted by the robot arm 102 (for example, approach distance of 0 cm from the robot arm 102 “contactable (0 cm approach)”). A human H1 is a worker who engages in the work of the robot arm 102 and is always around the robot arm 102.

In the conventional technique, in the ambient environment 105 of the robot arm 102, under predefinition that the robot arm 102 executes a task of grasping and moving the object O, the object O is set as a non-obstacle (task target), and the human H1 is set as an obstacle which is not preliminarily defined as a task target.

On the other hand, in the first embodiment, the control device 101 estimates an obstacle spectrum in the ambient environment 105 of the robot arm 102. The obstacle spectrum is continuous values estimated on the basis of a task target and real-time observation data from the sensor 103.

By the above, in the task of grasping the object O by the robot arm 102, the object O as a task target is grasped by the robot arm 102 and is therefore determined as “contactable (0 cm approach)”. The control device 101 predicts motions of the human H1 as a worker who is always around the robot arm 102, thereby determining the human H1 as “contactable (20 cm approach)”.

On the other hand, a human H2 is a person who runs from the outside of the ambient environment 105 and suddenly enters the ambient environment 105. The control device 101 predicts motions of the human H2, thereby determining that the human H2 “should be avoided (approach distance of 200 cm from the robot arm 102): “should be avoided (200 cm approach)””.

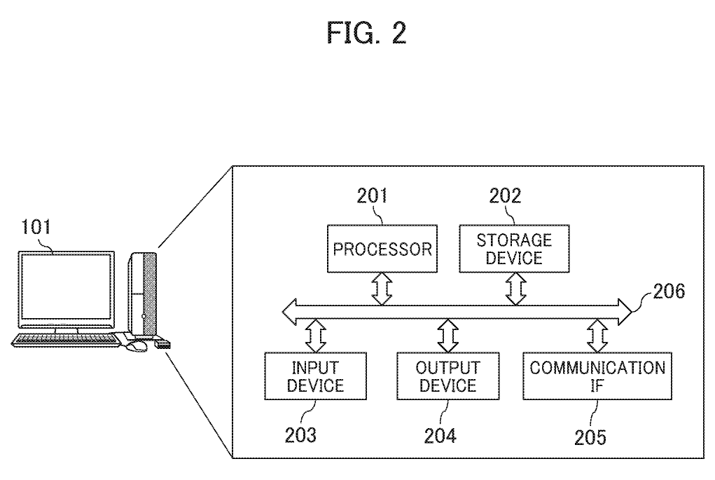

### FIG. 2 Hardware Configuration Example of Control Device 101

FIG. 2 is a block diagram illustrating a hardware configuration example of the control device 101. The control device 101 has a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls a control device 200. The storage device 202 is a work area of the processor 201. The storage device 202 is a non-transitory or transitory recording medium for storing various programs and data. Examples of the storage device 202 include a ROM (Read Only Memory), a RAM (Random Access Memory), an HDD (Hard Disk Drive), and a flash memory. The input device 203 receives data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 is connected to the network 104 and transmits/receives data.

For example, the control device 101 receives observation data from the sensor 103 via the communication IF 205 and transmits control data to the robot arm 102.

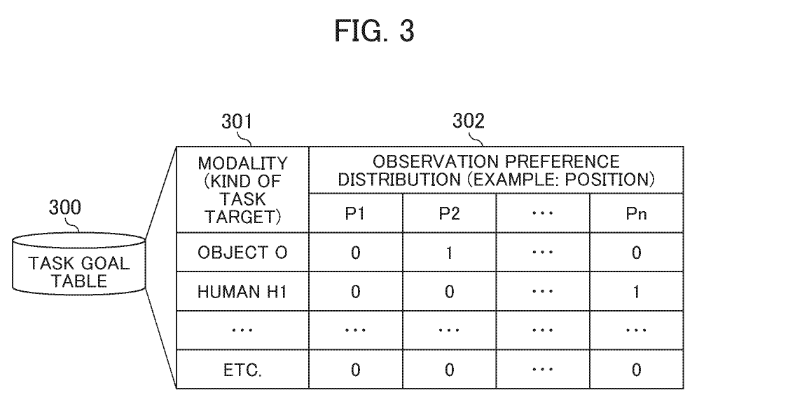

### FIG. 3 Task Goal Table

FIG. 3 is an explanatory diagram illustrating an example of a task goal table. A task goal table 300 has a modality 301 and an observation preference distribution 302.

The modality 301 indicates the kind of a task target such as the object O and the human H1. The observation preference distribution 302 is a set of random variables P1 to Pn at which the task targets specified by the modalities 301 are observed. The random variables P1 to Pn are, for example, positions observed by the sensor 103. When the sensor 103 is a fixed-point observation camera, each of the random variables P1 to Pn is a fixed position on a three-dimensional coordinate space in a camera coordinate system.

The observation preference distribution 302 for each modality 301 is expressed by a one-hot vector where the position of the value “1” is only one and the values in the other positions are “0” in the random variables P1, P2, …, and Pn. For example, with respect to the object O, since only the value in the position P2 is “1”, it is desirable that the object O exists in the position P2. Similarly, with respect to the human H1, since only the value in the position Pn is “1”, it is desirable that the object O exists in the position Pn.

The one-hot vector of the positions P1 to Pn indicating the observation preference distribution 302 for each of the modalities 301 will be called a task goal.

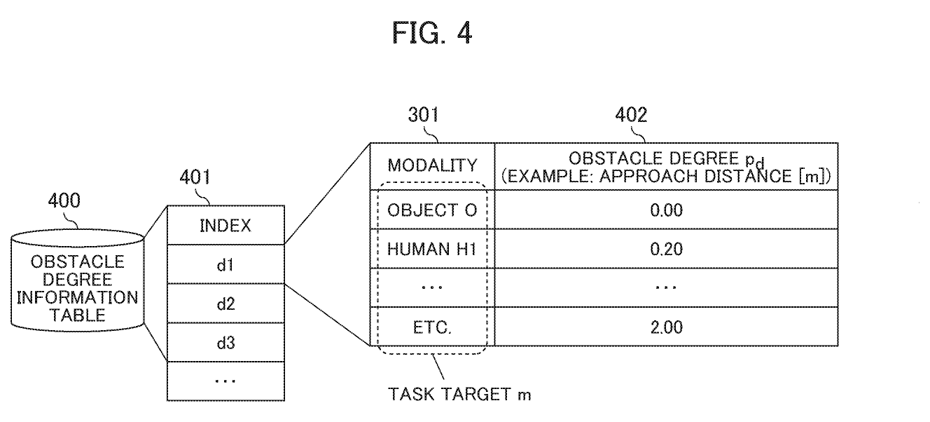

### FIG. 4 Obstacle Degree Information Table

FIG. 4 is an explanatory diagram illustrating an example of an obstacle degree information table. An obstacle degree information table 400 is a table for managing an obstacle degree. The obstacle degree information table 400 is stored in the storage device 202 of the control device 101. The obstacle degree information table 400 has an index 401. The index 401 is the way of considering an obstacle spectrum “b”, that is, the scale indicating the obstacle degree of the modality 301, and has the modality 301 and an obstacle degree 402. The obstacle degree 402 indicates a degree that a task target corresponds to an obstacle. Concretely, for example, the obstacle degree 402 indicates the border of whether a task target specified by the modality 301 is an obstacle or a non-obstacle.

For example, an index d1 indicates the degree that the robot arm 102 should avoid the modality 301. In the case of the index d1, the obstacle degree 402 is an approach distance from the robot arm 102, that is, the distance the modality 301 can approach the robot arm 102. For example, since the obstacle degree 402 of the object O is “0.00”, the object O may come into contact with the robot arm 102. Since the obstacle degree 402 of the human H1 is “0.20”, the human H1 may approach up to 0.20[m] to the robot arm 102.

An index d2 indicates movement speed of the robot arm 102. For example, a trajectory with a speed condition on which speed on the shortest path such as a straight line changes is generated.

An index d3 indicates resilience of the modality 301. For example, in the case where the surface of an object is covered with a soft material or the case where the operation part of a machine has passivity, the object or machine is not broken even if it is pressed to a certain extent. Consequently, the obstacle degree 402 may be regarded as an expectation value that the modality 301 makes avoidance according to the motion of the robot arm 102 (observation of the modality 301 changes).

The index d2 indicates the motion speed of the robot arm 102 and the resilience of the modality 301. For example, in the case where the surface of an object is covered with a soft material or the case where the operation part of a machine has passivity, the object or machine is not broken even if it is pressed to a certain extent. Consequently, the obstacle degree 402 may be regarded as an expectation value that the modality 301 makes avoidance according to the motion of the robot arm 102 (observation of the modality 301 changes).

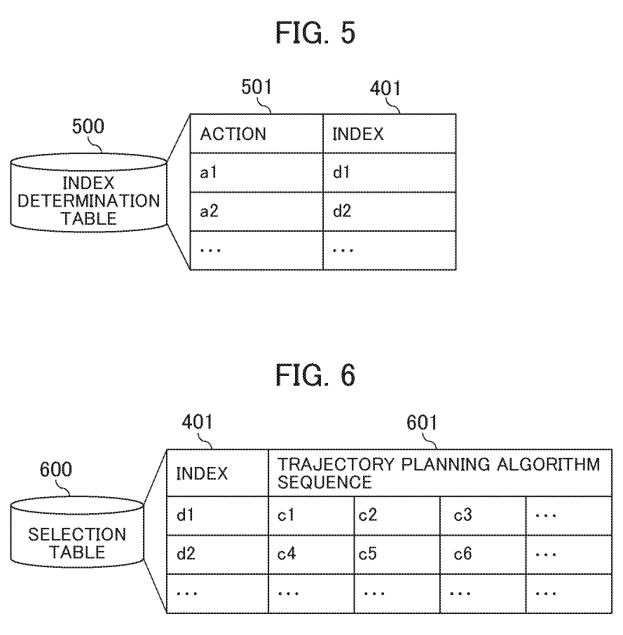

### FIG. 5 Index Determination Table

FIG. 5 is an explanatory diagram indicating an example of an index determination table. An index determination table 500 is a table which is referred to at the time of determining the index 401. The index determination table 500 is stored in the storage device 202 of the control device 101.

The index determination table 500 has an action 501 and the index 401. The action 501 is an action to be taken by the robot arm 102 and is generated by the control device 101. For example, in the case of a task of moving the object O from the position P2 to the position P3 by the robot arm 102, there are a plurality of actions such as “grasp the object O at the position P2”, “move the grasped object O to the position P3”, “release the object O at the position P”, and “when the object O does not exist at the position P2, stop at the position”. By referring to the index determination table 500, the index 401 of a task target according to the action 501 is determined.

### FIG. 6 Selection Table

FIG. 6 is an explanatory diagram illustrating an example of a selection table. A selection table 600 is a table which is referred to at the time of selecting a trajectory planning algorithm. The selection table 600 is stored in the storage device 202 of the control device 101.

The selection table 600 has the index 401 and a trajectory planning algorithm sequence 601. The trajectory planning algorithm sequence 601 is a sequence indicating priority order of trajectory planning algorithms. The priority order of selection is the highest at the left end, and the priority order of selection is the lowest at the right end. The trajectory planning algorithm is an algorithm of planning the trajectory of the robot arm 102 to realize a task, and is selected and executed by the control device 101.

As the trajectory plan algorithm, for example, there are: sampling-base trajectory planning algorithms such as Rapidly-exploring Random Tree (RTT) and Probabilistic Roadmap Method (RPM); trajectory planning algorithms based on optimal control and numerical optimization such as Model Predictive Control (MPC) and Linear Quadratic Regulator (LQR); trajectory planning algorithms based on a geometric method such as Dubins curve, Reeds-Shepp curve, and Bayes’ curve; trajectory planning algorithms based on machine learning such as deep RL (reinforcement learning) and imitation learning; and trajectory planning algorithms based on task space trajectory planning such as inverse kinematics and a method using Jacobian determinant.

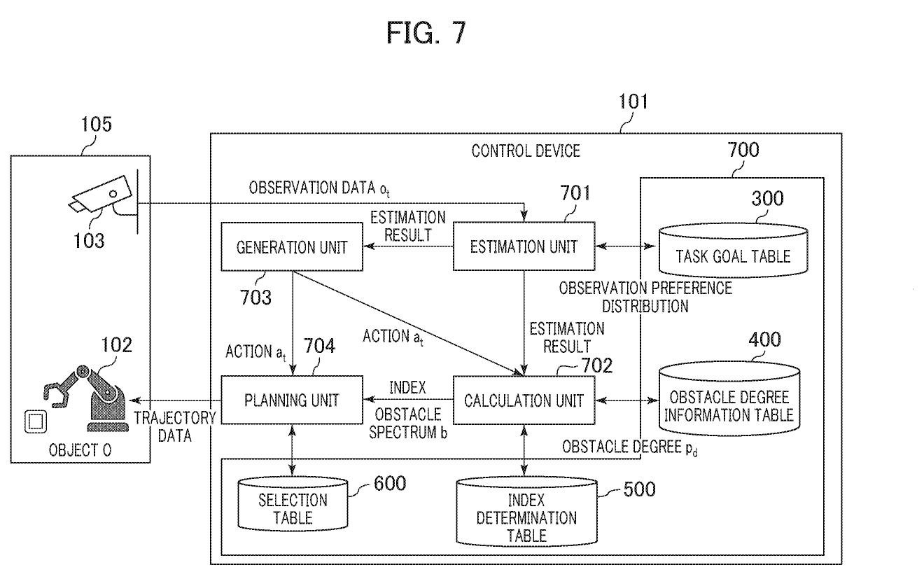

### FIG. 7 Functional Configuration Example of Control Device 101

FIG. 7 is a block diagram illustrating a functional configuration example of the control device 101. The control device 101 has a storage unit 700, an estimation unit 701, a calculation unit 702, a generation unit 703, and a planning unit 704. The storage unit 700 stores the task goal table 300, the obstacle degree information table 400, the index determination table 500, and the selection table 600. Concretely, the storage unit 700 is realized by, for example, the storage device 202 illustrated in FIG. 2.

Concretely, the estimation unit 701, the calculation unit 702, the generation unit 703, and the planning unit 704 are realized, for example, by making the processor 201 execute a program stored in the storage device 202 illustrated in FIG. 2.

The estimation unit 701 estimates a task target in observation data oₜ at time “t” output from the sensor 103, and outputs an estimation result to the calculation unit 702 and the generation unit 703. Concretely, for example, the estimation unit 701 obtains a recognized object from the observation data oₜ at the time “t” from the sensor 103. For example, when the observation data oₜ is image data, the estimation unit 701 detects a subject and its positional information (for example, the gravity center position of the subject in a camera coordinate system) as a recognized object by image recognition.

When the observation data oₜat the time “t” is input, the estimation unit 701 calculates a probability distribution pₜ (m|oₜ) for each recognized object by Bayes’ estimation. The estimation unit 701 may calculate the probability distribution pₜ (m|oₜ) for each recognized object not necessarily by Bayes’ estimation but an identification model configured by a convolutional neural network. The identification model is a model in which the relation between the observation data ot and a task target “m” is learned in advance.

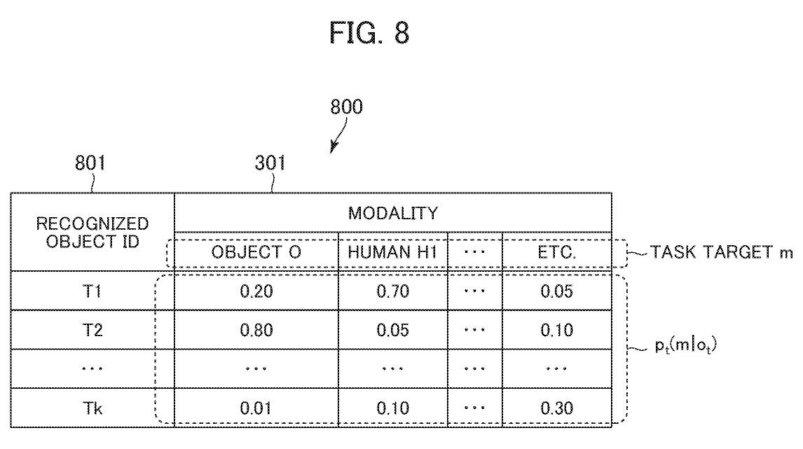

### FIG. 8 Probability Distribution pₜ (m|oₜ)

FIG. 8 is an explanatory diagram illustrating an example of a calculation result of the probability distribution pₜ (m|oₜ). In a calculation result 800 of the probability distribution pₜ (m|oₜ), a recognized object ID 801 is identification information (T1, T2, …, Tk) uniquely identifying a recognized object obtained from the observation data oₜ. Here, k denotes an integer of 1 or larger. There is a case where a recognized object whose recognized object ID 801 is Tk is described as a recognized object Tk.

The probability distribution pₜ (m|oₜ) is a probability that each of recognized objects Tk corresponds to a task target “m” specified by the modality 301. For example, the probability that a recognized object T1 is an object O is “0.20”, and the probability that the recognized object T1 is the human H1 is “0.70”. The probability that a recognized object T2 is the object O is “0.80”, and the probability that the recognized object T2 is the human H1 is “0.05”.

For example, it is assumed that the gravity center position of the recognized object T1 is closest to a position Pn among positions P1 to Pn, in the observation data oₜ at the time “t”. In the calculation result 800, the task target “m” of the highest probability in the probability distribution pₜ (m|oₜ) of the recognized object T1 is the human H1. Therefore, the estimation unit 701 identifies that the recognized object T1 existing in the position Pn in the observation data oₜ at the time “t” is the human H1.

Similarly, it is assumed that the gravity center position of the recognized object T2 is closest to the position P2 among the positions P1 to Pn in the observation data oₜ at the time “t”. In the calculation result 800, the task target “m” of the highest probability in the probability distribution pₜ (m|oₜ) of the recognized object T2 is the object O. Therefore, the estimation unit 701 identifies that the recognized object T2 existing in the position P2 in the observation data oₜ at the time “t” is the object O.

Also with respect to recognized objects T3 to Tk, the task targets “m” corresponding to the recognized objects T3 to Tk are estimated by a similar process.

Referring again to FIG. 7, the calculation unit 702 calculates the obstacle spectrum “b” and outputs it to the planning unit 704. Concretely, for example, the calculation unit 702 refers to the obstacle degree information table 400, identifies the estimated task target “m” from the modality 301, and obtains the obstacle degree 402 corresponding to the identified task target “m”. The value of the obtained obstacle degree 402 is set as pd (hereinafter, it may be described as an obstacle degree pd).

For example, when it is assumed that the present index 401 is d1, the calculation unit 702 reads “0.20” as the value pd of the obstacle degree 402 as the human H1 from the obstacle degree information table 400. The calculation unit 702 reads “0.00” as the value pd of the obstacle degree 402 when the modality 301 is the object O.

The calculation unit 702 calculates the obstacle spectrum “b” = 0.14 related to the human H1 by multiplying the probability “0.70” that the recognized object T1 is the human H1 with the value pd = “0.20” of the obstacle degree 402 that the modality 301 is the human H1. Similarly, the calculation unit 702 calculates the obstacle spectrum “b” = 0.00 related to the object O by multiplying the probability “0.80” that the recognized object T2 is the object O with the value pd = “0.00” of the obstacle degree 402 that the modality 301 is the object O.

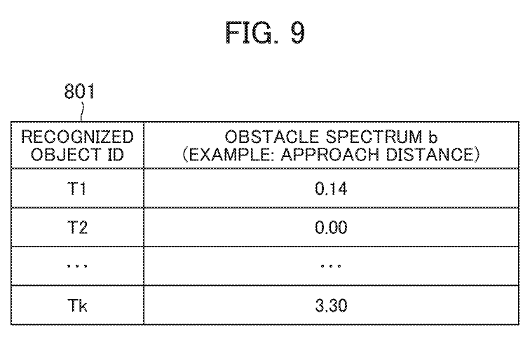

### FIG. 9 Obstacle Spectrum “b”

FIG. 9 is an explanatory diagram illustrating an example of a calculation result of the obstacle spectrum “b”. With respect to the task targets “m” corresponding to the recognized objects T3 to Tk as well, the obstacle spectrum “b” is calculated similarly.

Referring again to FIG. 7, the generation unit 703 generates an action aₜ of the robot arm 102 at the time “t” on the basis of the observation data oₜ at the time “t” and the probability distribution pₜ (m|oₜ) of the recognized object Tk, and outputs it to the planning unit 704 and the calculation unit 702. Concretely, for example, the generation unit 703 selects the action aₜ of the robot arm 102 to be taken at the time “t” from a plurality of actions 501 which are set in advance. For example, in the case of a task of moving the object O from the position P2 to the position P3 by the robot arm 102, the plurality of actions 51 include “grab the object O at the position P2”, “move the grabbed object O to the position P3”, “release the object O at the position P”, “when the object O is not at the position P2, stop at the position”, and the like.

Therefore, for example, in the case where the recognized object T2 is recognized in the observation data oₜ at the time “t” and the recognized object T2 exists in the position P2, it is estimated that the recognized object T2 is the object O.

The planning unit 704 plans a trajectory of the robot arm 102. Concretely, for example, the planning unit 704 refers to the selection table 600 and selects a trajectory planning algorithm corresponding to the present index 401 from the trajectory planning algorithm sequence 601. In this case, an unselected highest-priority trajectory planning algorithm is selected. For example, when the present index 401 is d1, the trajectory planning algorithm c1 is selected. Since the index d1 indicates the degree that avoidance should be made, a trajectory planning algorithm c1 using a gradient such as stochastic gradient descent is selected.

The planning unit 704 may fix the index 401 and select a trajectory planning algorithm corresponding to the index 401 from the trajectory planning algorithm sequence 601, or select a trajectory planning algorithm corresponding to the index 401 which is changed each time from the trajectory planning algorithm sequence 601.

The planning unit 704 generates, as control data, trajectory data of the robot arm 102 realizing the action aₜ from the generation unit 703 on the basis of the obstacle spectrum “b” by using the selected trajectory planning algorithm. The trajectory data is, for example, time-sequential change amounts of six axes of the robot arm 102. The planning unit 704 outputs the generated trajectory data to the robot arm 102. It makes the robot arm 102 execute the action aₜ in accordance with the received trajectory data.

The calculation unit 702 obtains the action aₜ from the generation unit 703. In this case, the calculation unit 702 may refer to the index determination table 500 and determine the index 401 corresponding to the obtained action 501(aₜ). The calculation unit 702 obtains the obstacle degree 402 corresponding to the determined index 401 for each task target “m” of the modality 301. In such a manner, according to a change in the index 401 corresponding to the latest action aₜ, the obstacle degree 402 can be automatically changed. In this case, the calculation unit 702 outputs the latest index 401 to the planning unit 704.

Whether the index 401 is fixed or changed in the calculation unit 702 and the planning unit 704 can be set in advance by a user operation.

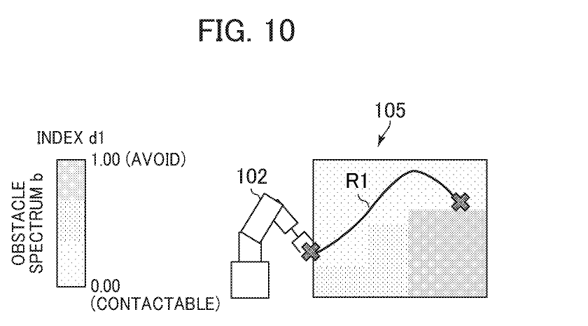

### FIG. 10 Trajectory Planning Example 1

FIG. 10 is an explanatory diagram illustrating trajectory planning example 1. The trajectory planning example 1 is a trajectory planning example in the case where the index 401 is the index d1 (the degree that avoidance should be made). The higher the value of the obstacle spectrum “b” is, the planning unit 704 generates trajectory data R1 of the robot arm 102 which avoids the area in the ambient environment 105 more. In this case, for example, a trajectory planning algorithm of executing a general path search using a gradient such as stochastic gradient descent is selected, the obstacle spectrum “b” is applied to a gradient, and the trajectory data R1 is generated. The content illustrated in FIG. 10 may be displayed on a display device as an example of the output device 204 of the control device 101.

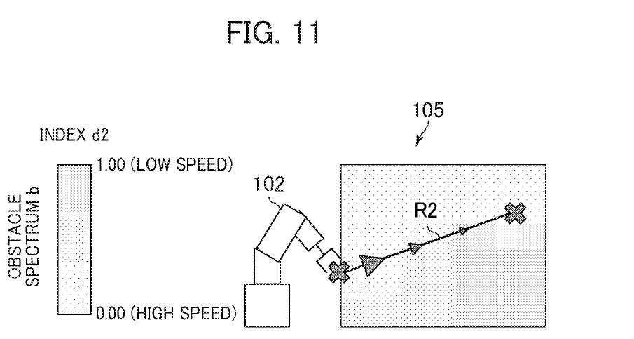

### FIG. 11 Trajectory Planning Example 2

FIG. 11 is an explanatory diagram illustrating trajectory planning example 2. The trajectory planning example 2 is a trajectory planning example in the case where the index 401 is the index d2 (the operation speed of the robot arm 102). The higher the value of the obstacle spectrum “b” is, the planning unit 704 generates trajectory data R2 as the shortest path of the robot arm 102 operating at low speed in the area in the ambient environment 105. The triangles on the trajectory data R2 express operation speeds of the robot arm 102. Specifically, the bigger the triangle is, the faster the operation speed is. The content illustrated in FIG. 11 may be displayed on a display device as an example of the output device 204 of the control device 101.

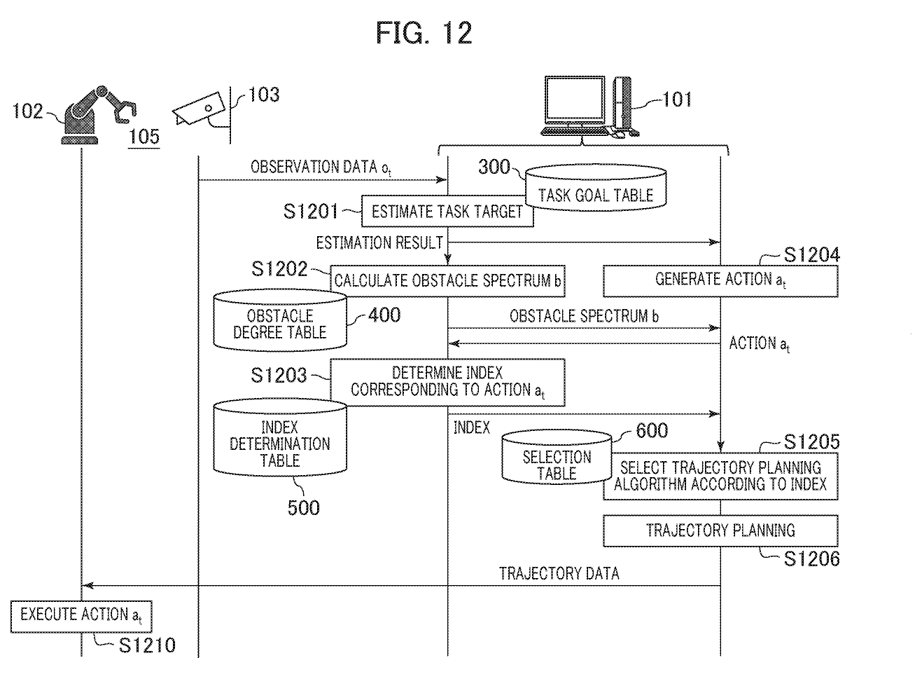

### FIG. 12 Control Operation

FIG. 12 is an explanatory diagram illustrating an example of a control operation process procedure of the robot arm 102 by the control device 101 according to the first embodiment. The vertical axis indicates lapse of time, arrows indicate transmission/reception of data, and rectangles indicate processes.

### Step S1201

When the control device 101 receives the observation data oₜ at the time “t” from the sensor 103, the estimation unit 701 estimates the task target “m” by referring to the task goal table 300. The task target “m” and its positional information are output as an estimation result to the calculation unit 702 and the generation unit 703.

### Step S1202

The control device 101 refers to the obstacle degree information table 400 on the basis of the estimation result from the estimation unit 701, and calculates the obstacle spectrum “b” related to the present index 401 by the calculation unit 702. The obstacle spectrum “b” is output to the planning unit 704.

### Step S1203

The control device 101 refers to the index determination table 500 and determines the index 401 corresponding to the action aₜ at the time “t” from the generation unit 703 by the calculation unit 702. The determined index 401 is output to the planning unit 704. In the case where the index 401 is fixed, step S1203 is not executed.

The control device 101 repeatedly executes the steps S1201 to S1203 each time the observation data oₜ is received.

### Step S1204

The control device 101 generates the action aₜ at the time “t” on the basis of the estimation result from the estimation unit 701. The action aₜ at the time “t” is output to the calculation unit 702 and the planning unit 704.

### Step S1205

The control device 101 refers to the selection table 600 and selects a trajectory planning algorithm according to the index 401 by the planning unit 704.

### Step S1206

The control device 101 executes a trajectory plan by the trajectory planning algorithm selected in step S1205. Trajectory data obtained by the trajectory plan is transmitted to the robot arm 102.

The control device 101 repeatedly executes the steps S1204 to S1206 each time an estimation result is obtained from the estimation unit 701.

### Step S1210

The robot arm 102 executes the action aₜ at the time “t” according to the trajectory data, and operates as the action aₜ at the time “t”. The control device 101 repeatedly executes the step S1210 each time trajectory data is received from the planning unit 704.

As described above, according to the first embodiment, both safety and approachability of the robot arm 102 can be realized according to the characteristics of a task target “m” of a task in which the robot arm 102 operates.

### SECOND EMBODIMENT

In a second embodiment, an example of determining success or failure of a trajectory plan in the first embodiment will be described. Since points different from the first embodiment will be mainly described in the second embodiment, the same reference numerals are designated to the same components as those of the first embodiment and description of repetitive parts will not be given.

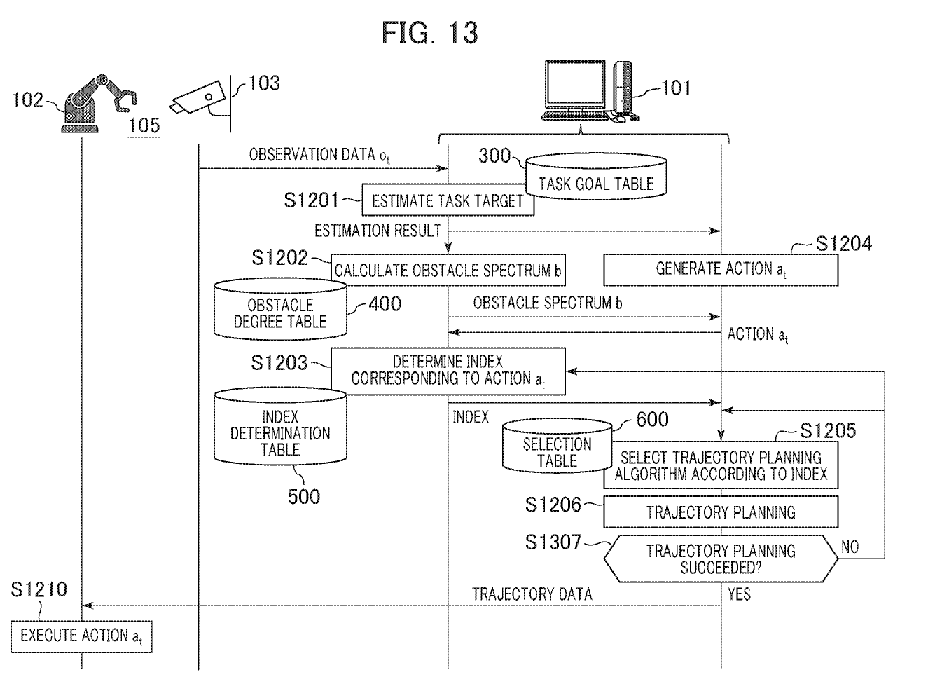

### FIG. 13 Control Operation

FIG. 13 is an explanatory diagram illustrating a procedure example of a control operation process of the robot arm 102 by the control device 101 according to the second embodiment.

### Step S1307

After execution of the trajectory planning in step S1206, the control device 101 determines whether the trajectory planning has succeeded or not by the planning unit 704. In the case where it is determined that the trajectory planning has succeeded (Yes in step S1307), the trajectory data is transmitted to the robot arm 102.

In the case where the trajectory planning algorithm could not generate a trajectory plan, the trajectory planning fails. For example, in the case where all directions of the robot arm 102 are surrounded by a recognized object Rk to be avoided at a degree that the index indicates avoidance, the trajectory planning fails by the trajectory planning algorithm.

In the case where the trajectory planning did not succeed (No in step S1307), the device moves to step S1203. In this case, the control device 101 refers to the selection table 600 and selects a trajectory planning algorithm which is not selected and has the highest priority by the planning unit 704 (step S1205). Consequently, the control device 101 re-executes the trajectory planning by using the trajectory planning algorithm newly selected by the planning unit 704 (step S1206).

In the case where the trajectory planning has not succeeded (No in step S1307) and in the case where there is no trajectory planning algorithm which is not selected by the present index 401, the control device 101 may move to step S1203 and change the present index 401 to an unselected index 401 by the calculation unit 702. In this case, the index 401 after the change is output to the planning unit 704. Therefore, the control device 101 can select a trajectory planning algorithm corresponding to the index 401 after the change by the planning unit 704 (step S1205).

In such a case, the control device 101 may determine a plurality of indexes 401 in the ambient environment 105 by the calculation unit 702, select a trajectory planning algorithm capable of applying a trajectory plan in the plurality of indexes 401 by the planning unit 704 (step S1205), and execute a trajectory plan for each of the selected trajectory planning algorithms (step S1206).

For example, since a trajectory planning algorithm capable of planning a trajectory in both of the indexes d1 and d2 is selected (step S1205), a trajectory in which the task target “m” is avoided more in a region where the obstacle spectrum “b” is larger and the speed of the operation of the robot arm 102 becomes low is planned (step S1206).

In such a case, the control device 101 may determine the indexes 401 which are different for divided regions of the ambient environment 105 by the calculation unit 702, select a trajectory planning algorithm for each of the indexes 401 of the divided regions by the planning unit 704 (step S1205), and execute a trajectory plan by a trajectory planning algorithm selected for each of the divided regions (step S1206).

Consequently, for example, the control device 101 executes a trajectory plan by a trajectory planning algorithm capable of making a trajectory plan in the index d2 in a divided region up to 0.5 m of the surrounding of the robot arm 102 by the planning unit 704, and executes a trajectory plan by a trajectory planning algorithm capable of making a trajectory plan in the index d1 in further distant divided regions.

### THIRD EMBODIMENT

As a third embodiment, an example in which an actuator as a control target of the control device 101 in the first and second embodiments is a trolley robot which can travel autonomously will be described. Since points different from the first and second embodiments will be mainly described in the third embodiment, the same reference numerals are designated to the same components as those in the first and second embodiments, and description of repetitive parts will not be given.

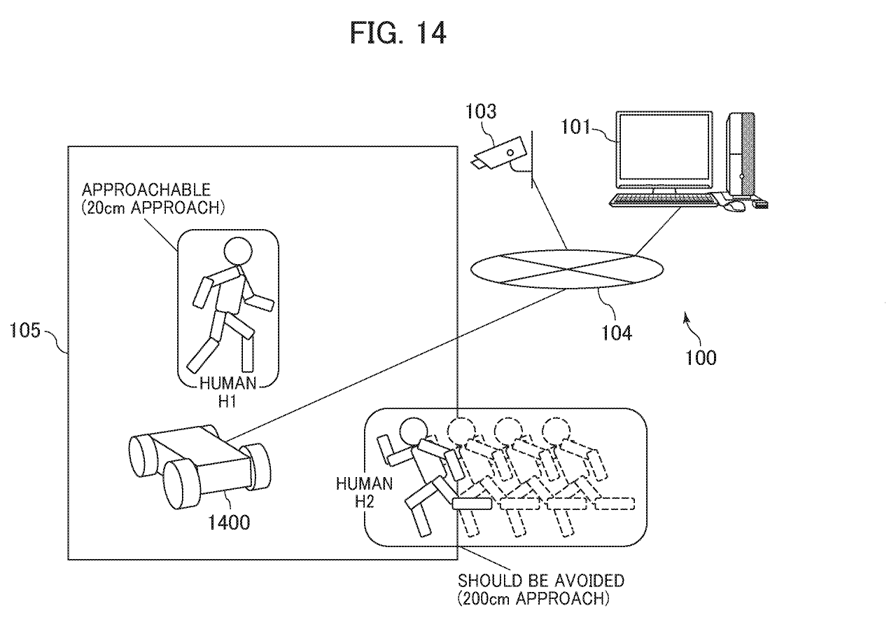

### FIG. 14 Trolley Robot Control Example 1

FIG. 14 is an explanatory diagram illustrating trolley robot control example 1 according to the third embodiment. For example, in the case where a human and a trolley robot 1400 move together in a distribution warehouse for a picking work in the warehouse, a human H1 who moves together is a task target “m” which can be approached but an unrelated human H2 is regarded as a task target which has to be avoided. In the case where a control target is the trolley robot 1400, the planning unit 704 searches for a travel path in which the trolley robot 1400 travels to a destination point as a trajectory.

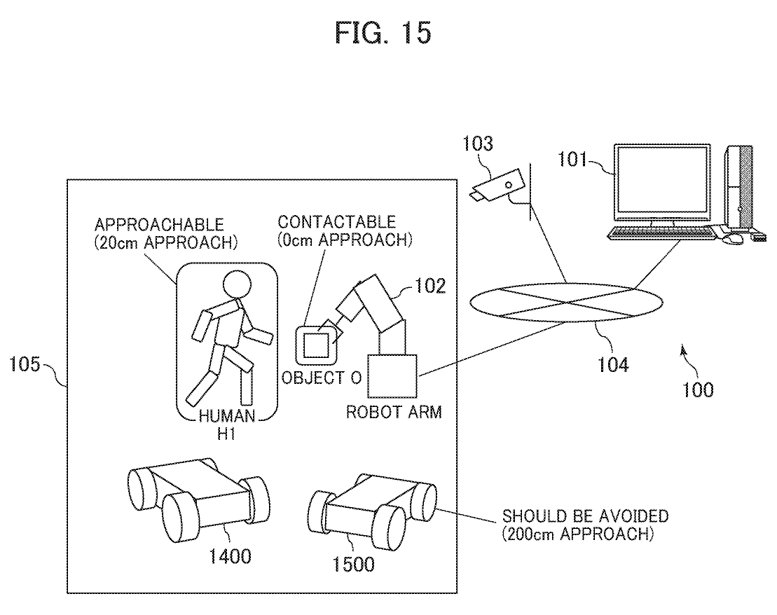

### FIG. 15 Trolley Robot Control Example 2

FIG. 15 is an explanatory diagram illustrating trolley robot control example 2 according to the third embodiment. FIG. 15 illustrates an example of a task that an object O carried by the trolley robot 1400 is picked by the robot arm 102. In this case, the trolley robot 1400 is a task target “m” which can approach the robot arm 102. On the other hand, a trolley robot 1500 which engages in another work is a task target “m” the robot arm 102 should avoid.

The control device 101 operates and controls the robot arm 102 and the trolley robot 1400 independently. Specifically, with respect to the robot arm 102, the control device 101 plans the trajectory data R1 and R2 of the robot arm 102 by the planning unit 704 as described in the first and second embodiments, and searches for a travel path in which the trolley robot 1400 travels to a destination point (the robot arm 102 or a place of storing the object O).

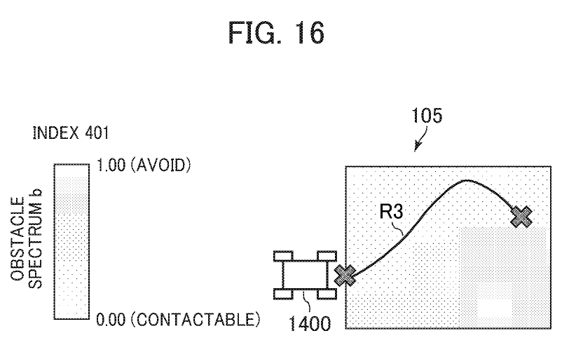

### FIG. 16 Trajectory Planning Example

FIG. 16 is an explanatory diagram illustrating a trajectory planning example according to the third embodiment. FIG. 16 is a trajectory planning example in the case where the index 401 is the index d1 (the degree that avoidance has to be made). The higher the value of the obstacle spectrum “b“ is, the planning unit 704 generates trajectory data R3 of the trolley robot 1400 which avoids the region in such an ambient environment 105 more. The trajectory data R3 is expressed by time-sequence travel direction, travel speed, and turn angle of the trolley robot 1400.

For example, by selecting a trajectory planning algorithm of executing a general path search using a gradient such as stochastic gradient descent and applying the obstacle spectrum “b” to the gradient, the trajectory data R3 is generated. The content illustrated in FIG. 16 may be displayed in a display device as an example of the output device 204 of the control device 101.

As described above, even a control target which can travel like the trolley robot 1400, both safety and approachability of the control target (trolley robot 1400) can be realized according to the characteristics of the task target “m”.

The present invention is not limited to the above-described embodiments, and various modifications and equivalent configurations are included in the gist of the appended scope of claims for a patent. For example, the above-described embodiments have been described in detail in order to facilitate the understanding of the present invention, and the present invention is not necessarily limited to those including all of the described configurations. A part of the configuration of a certain embodiment may be replaced by the configuration of another embodiment. The configuration of a certain embodiment may be added to the configuration of another embodiment. In addition, part of the configuration of each of the examples can be subjected to addition, deletion, and replacement with respect to other configurations.

A part or all of the above-described configurations, functions, processing units, processing means, and the like may be realized by hardware by, for example, designing them in an integrated circuit, or realized by software by interpreting and executing programs realizing the functions by a processor.

Information of a program, a table, a file, and the like realizing each function can be stored in a storage device such as a memory , a hard disk, an SSD (Solid State Drive), or the like or a recording medium such as an IC (Integrated Circuit) card, an SD card, or a DVD (Digital Versatile Disc).

Control lines and information lines which are considered to be necessary for description are illustrated. All of control lines and information lines necessary for mounting are not always illustrated. It may be considered that all of configurations are connected mutually in practice.

What is claimed is:

1. A control device comprising:
a storage unit for storing an observation preference distribution of each task target as a target of a task in which a control target operates, and obstacle degree information indicating a degree that the task target corresponds to an obstacle;
an estimation unit for estimating that an object in an ambient environment of the control target is which task target on the basis of observation data from a sensor for observing the ambient environment of the control target and the observation preference distribution;
a calculation unit for calculating an obstacle spectrum indicating an obstacle degree of a result of estimation by the estimation unit on the basis of the obstacle degree information;
a generation unit for generating an action of the control target on the basis of the estimation result; and
a planning unit for planning control data which controls the control target on the basis of an obstacle spectrum calculated by the calculation unit and an action generated by the generation unit.

2. The control device according to claim 1, wherein
the preference distribution is made by random variables of positions in the ambient environment of the task target.

3. The control device according to claim 1, wherein
the planning unit outputs the control data to the control target, and
the estimation unit estimates that the object in the ambient environment after the control target executes the action is which task target, on the basis of observation data of observation made by the sensor after the control target executes the action according to the control data which is output from the planning unit to the control target and the observation preference distribution.

4. The control device according to claim 1, wherein
the storage unit stores selection information in which a priority is associated with an algorithm of planning the control data, and
the planning unit tries planning of the control data by a first algorithm of a first priority, determines success or failure of the planning and, in the case where it is determined that the planning fails, selects a second algorithm of a second priority from the selection information, and tries planning of the control data.

5. The control device according to claim 1, wherein
the obstacle degree information is set for each index of the task as a way of regarding the obstacle spectrum,
the storage unit stores index determination information in which the action and the index are associated, and selection information which specifies an algorithm of planning the control data for each of the indexes,
the calculation unit determines the index corresponding to the action generated by the generation unit by referring to the index determination information, and
the planning unit selects an algorithm of the index determined by the calculation unit from the selection information and tries planning the control data.

6. The control device according to claim 1, wherein
the storage unit stores selection information which specifies an algorithm of planning the control data for each index of the task as a way of regarding the obstacle spectrum, and
the planning unit tries planning the control data by a first algorithm of a first index, determines success or failure of the planning and, when it is determined that the planning fails, selects a second algorithm of a second index which is different from the first index from the selection information and tries planning the control data.

7. The control device according to claim 1, wherein
the task is a task of grasping an object and moving the object by the control target.

8. The control device according to claim 1, wherein
the task is a task of making the control target travel to a destination point.

9. A control method executed by a control device that includes a processor which executes a program, a storage device that stores the program, and a communication interface that can communicate with a sensor for observing a control target and its ambient environment,
the control method comprising:
causing the storage device to store an observation preference distribution of each task target as a target of a task in which the control target operates, and obstacle degree information indicating a degree that the task target corresponds to an obstacle, and
causing the processor to execute
an estimating process of estimating that an object in the ambient environment is which task target on the basis of observation data from the sensor and the observation preference distribution,
a calculating process of calculating an obstacle spectrum indicating an obstacle degree of a result of estimation by the estimating process on the basis of the obstacle degree information,
a generating process of generating an action of the control target on the basis of the estimation result, and
a planning process of planning control data which controls the control target on the basis of an obstacle spectrum calculated by the calculating process and an action generated by the generating process.

10. A non-transitory processor-readable medium for control storing a control program which is executed by a processor of a control device including the processor which executes a program, a storage device which stores the program, and a communication interface which can communicate with a sensor for observing a control target and its ambient environment,
the control program causing:
the storage device to store an observation preference distribution of each task target as a target of a task in which the control target operates and obstacle degree information indicating the degree that the task target corresponds to an obstacle; and
the processor to execute
an estimating process of estimating that an object in the ambient environment is which task target on the basis of observation data from the sensor and the observation preference distribution,
a calculating process of calculating an obstacle spectrum indicating an obstacle degree of a result of estimation by the estimating process on the basis of the obstacle degree information,
a generating process of generating an action of the control target on the basis of the estimation result, and
a planning process of planning control data which controls the control target on the basis of an obstacle spectrum calculated by the calculating process and an action generated by the generating process.
